(19) United States
(12) Patent Application Publication
(10) Pub. No.: US 2016/0305847 A1
(43) Pub. Date: Oct. 20, 2016

(54) COMPUTER DEVICE FOR DETECTING CORRELATIONS WITHIN DATA

(71) Applicant: SIEMENS AKTIENGESELLSCHAFT, Muenchen (DE)

(72) Inventors: ALEXANDER GERASIMOV, VOLGOGRAD (RU); PAVEL KUDRYASHOV, VOLGOGRAD (RU); MIKHAIL ROSHCHIN, MÜNCHEN (DE); STUART WATSON, NEWARK (GB)

(73) Assignee: SIEMENS AKTIENGESELLSCHAFT, MUNCHEN (DE)

(21) Appl. No.: 15/101,990

(22) PCT Filed: Dec. 16, 2013
(86) PCT No.: PCT/RU2013/001129

§ 371 Date: Jun. 6, 2016

(51) Int. Cl. G01M 15/14; G06F 17/30

(52) U.S. Cl. CPC G01M 15/14; G06F 17/30964

(57) ABSTRACT

A computer device for detecting correlations within data received from a technical system is provided. The computer device includes a receiving unit for receiving numerical data from the technical system, a processing unit for processing the numerical data by converting the numerical data into text-based data and by detecting predefined events in the text-based data, a comparison unit for comparing the detected events with predefined queries, wherein the predefined queries describe correlations between detected events, to provide a comparison result, and a signaling unit for outputting a signal based on the provided comparison result. By converting numerical data into text-based data, correlations within the data can be easily detected based on predefined queries, which are also in text-based form. Thus, users without further knowledge of the numerical data can set queries. Further, a technical system including such a computer device and a corresponding method are provided.

### CROSS-REFERENCE TO RELATED APPLICATIONS

This application claims priority to PCT Application No. PCT/RU2013/001129, having a filing date of Dec. 16, 2013, the entire contents of which are hereby incorporated by reference.

### FIELD OF TECHNOLOGY

The following relates to a computer device for detecting correlations within data received from a technical system and a technical system comprising such a computer device. Further, the following relates to a method for detecting correlations within data received from a technical system and a computer program product comprising a program code for executing such a method.

### BACKGROUND

In several technical systems, for instance rotating equipment like turbines or generators, diagnostics itself and related diagnosis procedures, involve a comprehensive analysis of very large volumes of data for a longer time period, depending on the complexity of an investigated problem. The data consists of both textual messages from control units in the form of text strings, referred to as events in this domain, and sensor signals, referred to as measurements. Events from control units, also known as sequences of events, may contain significant information for diagnostics. But analysis based on this information by itself is expensive in time and cost and is not related to further information from sensors.

In common systems, methods are used which use either nominal information such as text mining, ontologies, complex event processing, or use numerical data such as discrete and stochastic methods, learning algorithms and generally mathematics.

### SUMMARY

An aspect relates to improving the processing of data received from technical systems based on numerical and nominal data.

Accordingly, a computer device for detecting correlations within data received from a technical system is provided. The computer device comprises a receiving unit for receiving numerical data from the technical system, a processing unit for processing the numerical data by converting the numerical data into text-based data and by detecting predefined events in the text-based data, a comparison unit for comparing the detected events with predefined queries to provide a comparison result, wherein the predefined queries describe correlations between detected events, and a signaling unit for outputting a signal based on the provided comparison result.

The computer device is based on the idea of converting the received numerical data into text-based data, i.e. nominal data, such that a comparison with text-based queries can be easily performed. Users who have no further knowledge of programming or programming languages can thus formulate text-based queries which can directly be compared with events detected in the converted text-based data. The text-based data may be based on a grammar which can be defined beforehand. The grammar may define events as well as any kind of correlation using a specific language based on the grammar.

The processing unit, the comparison unit and the signaling unit may be separate units or may be combined, for instance in a central processing unit.

The processing unit, when converting the numerical data into text-based data, may perform an analysis of the received numerical data and transform the numerical data into text-based data including the information of the numerical data in text-based form. Converting in this context may thus refer to analyzing and transforming numerical data into text-based data. The processing unit may then examine the text-based data in view of predefined events. The predefined events may be stored in a data base and describe or define for instance specified conditions of the technical system.

A computer device in this context may refer for instance to a personal computer or workstation but also to mobile devices like smartphones or tablet PCs. The computer device may comprise a display unit such as a monitor for displaying the output signal to a user.

According to an embodiment, the signaling unit is adapted to output a signal when the result of the comparison is positive.

The comparison unit may perform a comparison of the events of the text-based data and the predefined queries which may also be in text form. If the query describes a correlation between two events, the comparison unit determines whether both events are fulfilled. If yes, the signal unit outputs a signal. The signal may be for instance a warning signal informing a user about the occurrence of the combination of the events.

According to a further embodiment, the receiving unit is adapted to receive numerical sensor data from at least one sensor of the technical system and/or numerical measurement data from at least one measurement unit of the technical system.

The technical system may comprise at least one sensor sensing for instance a temperature, speed, rotation or any other kind of condition or status being measurable by sensors. In addition or alternatively, the technical system may comprise measurement units for measuring information within the technical system.

According to a further embodiment, the receiving unit is adapted to receive operation commands from at least one control unit of the technical system, and the comparison unit is adapted to compare the detected events and the operation commands with predefined queries.

In addition to sensor data or measurement data, operation commands can be taken into account when comparing the received numerical data, after conversion, with predefined queries. For instance, a query may define that the user wants to be informed if a specific operation command has been issued and a specific event, i.e., a specific condition or status, of the technical system occurs.

According to a further embodiment, a predefined query describes a correlation between a plurality of detected events.

The queries may also describe more than two events which need to be fulfilled before resulting in an output signal. These events may have a relation to each other, but may also be independent from each other.

According to a further embodiment, the predefined query describes a temporal correlation between the plurality of detected events.

According to this embodiment, at least two events may have a temporal correlation. The temporal correlation may be an offset between two or more events or may describe that the two or more events occur at the same time. Also a combination of these correlations may be described, e.g., two events occur at the same time and the third event a predefined time interval later.

According to a further embodiment, the predefined query describes a logical correlation between the plurality of detected events.

A logical correlation may correspond to any known logic operations like AND, NOR, NAND, XOR and so on. Also a combination of temporal and logical correlations may be described by the predefined queries.

According to a further embodiment, the processing unit includes a filter for filtering specific detected events.

According to this embodiment, specific detected events may be ignored by filtering. Thus, it may be defined in a query that some events need to be fulfilled whereas other events are ignored.

According to a further embodiment, the detected events include at least one of a trend of the detected event, a gap within the detected event, a minimum value of the detected event, a maximum value of the detected event, and an average value of the detected event.

If an event describes a changing or varying signal like temperature, voltage, current, speed or the like, the processing unit may determine the kind of change when detecting the events. These changes or variations within the signals can be part of predefined queries which then describe a varying event and not only a static event. However, a detected event can also correspond to a threshold such as a minimum value or maximum value.

According to a further embodiment, the computer device further comprises an input unit for receiving input information from a user, the input information including predefined queries.

The input unit may be for example a monitor, a keyboard, a mouse, a touchpad or any other kind of input unit.

According to a further embodiment, the input information is in text-based form.

As the input information is in text-based form, also users having no deeper knowledge of programming languages can define and input queries.

The above described computer device provides a simple approach to combine text-based information, i.e. predefined queries from users and operation commands from control units of the technical system, as well as numerical data from sensors. By filtering and preprocessing huge amounts of numerical data, which can be done directly by a diagnosis engineer, not a programmer, the comparison of the numerical data and the text-based queries can be easily performed. The computer device thus provides a user friendly way to represent rules, i.e. queries and comparison results, based on sensor measurements and their characteristics without any advanced knowledge of mathematics. An automated correlation of various sensor measurements can be performed by using various logical operators (AND, OR, NOT, etc.) as well as temporal correlations (after, before, coincides, etc.) for high-dimensional data. By placing together both information sources, i.e. numerical and text-based data, from any technical system, e.g. from rotating equipment, in the form of events in order to process them within one computer device, knowledge can be shared among various diagnosis engineers in well-known language without further knowledge of mathematics or programming languages.

According to a further aspect, a technical system is provided. The technical system comprises a plurality of sensors for providing numerical data from the technical system, and a computer device as described above.

According to an embodiment, the technical system is one of a wind turbine, a gas turbine, a steam turbine, a compressor, and a generator.

The sensors of the technical systems may be any sensors for detecting and/or monitoring conditions of the technical system, in particular of rotating equipment.

According to a further aspect, a method for detecting correlations within data received from a technical system is provided. The method comprises receiving numerical data from the technical system, processing the numerical data by converting the numerical data into text-based data and by detecting predefined events in the text-based data, comparing the detected events with predefined queries to provide a comparison result, wherein the predefined queries describe correlations between detected events, and outputting a signal based on the provided comparison result.

According to a further aspect, embodiments of the invention relate to a computer program product comprising a program code for executing the above-described method for detecting correlations within data received from a technical system when run on at least one computer.

A computer program product, such as a computer program means, may be embodied as a memory card, USB stick, CD-ROM, DVD or as a file which may be downloaded from a server in a network. For example, such a file may be provided by transferring the file comprising the computer program product from a wireless communication network.

The embodiments and features described with reference to the apparatus of the present invention apply mutatis mutandis to the method of embodiments of the present invention.

Further possible implementations or alternative solutions of the embodiments of the invention also encompass combinations—that are not explicitly mentioned herein—of features described above or below with regard to the embodiments. The person skilled in the art may also add individual or isolated aspects and features to the most basic form of embodiments of the invention.

### BRIEF DESCRIPTION

Some of the embodiments will be described in detail, with reference to the following figures, wherein like designations denote like members, wherein:

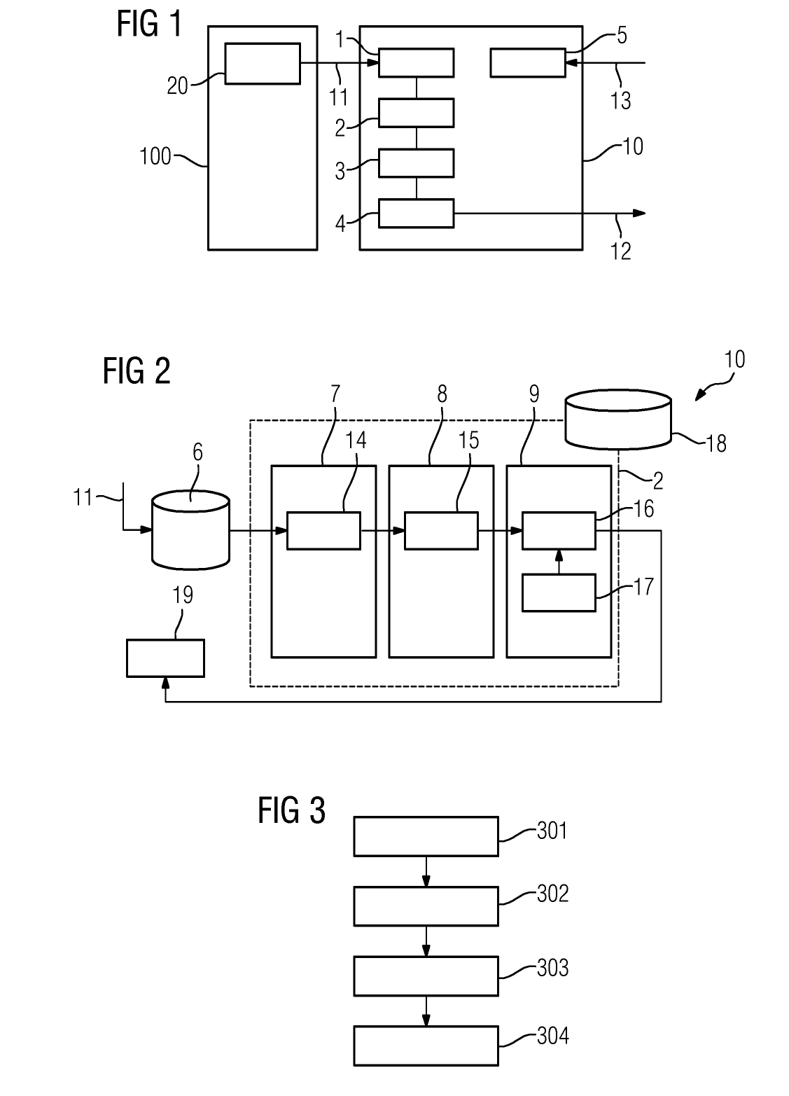

FIG. 1 shows a first example of a representation of a computer device for detecting correlations within data received from a technical system;

FIG. 2 shows a second example of a representation of a computer device for detecting correlations within data received from a technical system; and

FIG. 3 shows an embodiment of a sequence of method steps for detecting correlations within data received from a technical system.

In the Figures, like reference numerals designate like or functionally equivalent elements, unless otherwise indicated.

### DETAILED DESCRIPTION

FIG. 1 illustrates a first example of a computer device 10. The computer device 10 comprises a receiving unit 1 for receiving numerical data 11 from sensors 20 of a technical system 100. The receiving unit 1 may be coupled to sensors or may be coupled to a sending unit of the technical system 100.

A processing unit 2 processes the numerical data 11. The processing unit 2 converts the numerical data 11 into text-based data and detects predefined events in the text-based data. A comparison unit 3 compares the detected events with predefined queries to provide a comparison result.

The predefined queries are input as input information 13 to an input unit 5. The predefined queries describe correlations between detected events, for instance temporal or logical correlations. A signaling unit 4 outputs a signal 12 based on the provided comparison result. The signal 12 can be a warning signal to indicate a specific combination of events.

In FIG. 2, a second example of a computer device 10 is illustrated. Here, the processing unit 2 is shown in detail. The remaining parts of the computer device 10 of FIG. 1 can also be present, although not shown in FIG. 2.

The numerical data 11 is stored in a data base 6. The processing unit 2 comprises a further data base 18 in which predefined events as well as queries can be stored.

The numerical data 11 can be retrieved by a mathematical processing unit 7. The mathematical processing unit 7, which comprises a processor 14, determines mathematical events such as average values, minimum values or maximum values. In a processing recognition unit 8, which comprises an event emitter 15 for detecting further events, trends of the data 11 or gaps within the data 11 can be recognized. The processing recognition unit 8 is adapted to detect logical or temporal characteristics of the events.

In an event processing unit 9, which comprises a processor 16, logic rules can be applied by a logic rules converter 17. Thus, the detected events can be preprocessed before being supplied to the comparison unit 3 which is not shown in FIG. 2.

The finally detected events can be shown on a display unit 19. Also the comparison result can be displayed on the display unit 19.

An example of a grammar being used for describing events and correlations between events will be explained in the following. It should be noted that also other grammar can be used or that the described grammar can be extended.

The grammar for describing events and correlations can be context free. An “event” and its definition are considered to be a term of a category signal.

The following are examples of the language, i.e. grammar, which can extend an event processing technology “Drools Fusion”:

```
<formula>  ::=  <formulaHeader> = <logicalExpression>;
<formulaHeader>  ::=  (<signalVariable> :)? signal(String)
      <attributes>*
<variable>  ::=  $<identifier> :
<identifier>  ::=  [a-z]|[A-Z]|‘_’
<attributes>  ::=  : internal
                  | : period (once|<time>)
                  | : off
                  | : switch(on|off, <variableList>)
<variableList>  ::=  <variable> , (variable)*
<logicalExpression> ::=  not <logicalExpression>
                  | <logicalExpression> and <logicalExpression>
                  | <logicalExpression> or <logicalExpression>
                  | <logicalExpression>
                  | <eventExpression>
                  | ( <logicalExpression> )
<eventExpression>  ::=  (<variable> :)? <eventEmitter> <tem
      poralConstraint>)?
<eventEmitter>  ::=  trend((upldown), <dataExpression>, <dura
      tionConstraint>)
                  | comparison((==|!=|>|>=|<|<=),
                      <dataExpression>, <dataExpression>,
      <durationConstraint>)
                  | gap(<dataExpression>,<durationConstraint>)
<dataExpression>  ::=  - <dataExpression>
                  | <dataExpression> (*|/) <dataExpression>
                  | <dataExpression> (+|−) <dataExpression>
                  | <dataCalculation> <filterList>
                  | <identifier> <filterList>
                  | Integer
                  | ( <dataExpression> ) <filterList>
<dataCalculation>  ::=  sd(<dataExpression>, <time>)
                  | sd (<dataExpression>, Integer)
                  | avg(<dataExpression>, <time>)
                  | avg(<dataExpression>, Integer)
                  | mean(<dataExpression>(,<dataExpression>)*)
                  | abs(<dataExpression >)
                  | min(<dataExpression>(,<dataExpression>)*)
                  | max(<dataExpression>(,<dataExpression>)*)
                  | pow(<dataExpression>, <dataExpression>)
<filterList>  ::=  filter*
<filter>  ::=  ignorable
                  | repeat <time>
                  | expires <time>
<durationConstraint>::=  (>=|<=) <time>
<time>  ::=  (Digit+‘d’) (Digit+‘h’)? (Digit+‘m’)? (Digit+‘s’)?
(Digit+‘ms’)?
(specifies Drools notation)  |  (Digit+‘h’) (Digit+‘m’)?
      (Digit+‘s’)?(Digit+‘ms’)?
                  | (Digit+‘m’) (Digit+‘s’)? (Digit+‘ms’)?
                  | (Digit+‘s’) (Digit+‘ms’)?
                  | Digit+‘ms’
<temporalConstraint>?  ::=  <startConstraint>?
                  | <endConstraint>?
                  | <lastConstraint>?
                  | <completedConstraint>?
                  | <incompletedConstraint>?
<startConstraint>  ::=  : start (correlationCondition
      (,correlationCondition)*)
                  | : s (correlationCondition
      (,correlationCondition)*)
<endConstraint>  ::=  : end (correlationCondition  (,
constraintOperator)*)
                              : e (correlationCondition
          (,correlationCondition)*)
constraintOperator  ::=  after [<time> (, <time>)?]? variable  Colon
(start|s|end|e)
                  | before [<time> (, <time>)?]? variable
      Colon (start|s|end|e)
                  | coincides [<time>]? variable Colon
      (start|s|end|e)
                  | over <time>
<lastConstraint> ::=  : last(Integer|*)
<completedConstraint>  ::=  : completed
<incompletedConstraint> ::=  : !completed
```

The above listed grammar can be used to define various events, correlations between these events as well as queries, which will be described in the following. The term “rule” refers to predefined events.

A formula consists of two parts, a header and a formula expression, separated by a “=” symbol. The formula header has the form “signal(“event name”)”; there can be a reference definition for this formula before the expression (“$s1:”). After the expression with leading colon, optional attributes are located in arbitrary order:
“: internal” means that the current signal is used only as an intermediate internal event, generated for other rules within the current bunch of formulas
“: period (once|Time)” applies a filter with the following meaning: “How long it takes after previous event match to consider next match of this formula”
“once” means that the rule will execute only one time

Logical expressions include logical operands, such as AND, OR, NOT operators (not case-sensitive) and parenthesis:
AND has a greater priority than OR
NOT refers directly to the next operand, i.e. NOT A AND B means (NOT A) AND B;
   To assign NOT for expression it is necessarily to use explicit parenthesis
   Logical operand (dataExpression) is an event emitter
   A & B: e(before A:e)

An event emitter includes:
Optional variable definition with the meaning “process” (such an event always starts with “$” symbol)
   If the variable is specified, a colon symbol is required after the variable definition
Definition of process event emitter
Optional emitter attributes with a leading colon symbol and an arbitrary order

Event emitter attributes include:
“: start( )” or “s( )”—correlation conditions of the event start are located between parenthesizes, separated by comma
   Operators “after”, “before”, “coincides” with optional temporal constraints.

Temporal constraints contain references to a binding point as a variable and a bound of an event (“start” or “end”) into brackets.
“over 1 h” specifies the time window of the event start (whether the event must start within a specified time interval relative to the current moment of time)
If into parenthesis nothing is specified, then this attribute is equivalent to the absence of the start( ) attribute
“: end( )” of “e( )”—correlation conditions of the event end are located between parenthesizes, separated by comma
Operators “after”, “before”, “coincides” are the same in usage as described above for the start( ) section
“over 1 h” specifies the time window of the event end (whether the event must end within a specified time interval relative to the current moment of time)
“: last(count)”—window by event count (how many such last events should be considered);
by default for all event emitters constraint “:last(1)” is applied, i.e. such a formula correlate only with the last event from the series, so it is not necessary to specify constraint “:last(1)” explicitly;
to correlate all events, generated by an emitter, it is necessary to use “:last(*)”
“:completed”—the process described by the event must have been completed by the moment of the formula activation to consider this event
“: !completed”—the process described by the event must be incompleted by the moment of the formula activation signal(“Simple completed trend event for last 10 values, which expires in 1 m”)

Event process emitter (event process generator) describes:
Identifier of operation (e.g. trend, comparison etc.)
Operation parameters into parenthesizes (mathematical expressions, and special expressions, depending on the emitter type)

Trend can be:
Trend can be raising (“up” trend direction) or falling (“down”)
Second parameter of the trend is a result of a calculation of mathematical expressions under data. It is used as a data source for the trend calculation
Duration constraint consists of a comparison operation (<=, >=) and a time interval.
   A trend event is reasoned only if it's not interrupted during the whole duration period

Comparison emits events when comparing data expressions are satisfied by the comparison operator (==, !=, >, >=, <, <=) within a time constraint.

Gap emits events when the data expression contains gaps in the data.
Time duration constraint for the gap emitter has only a >=constraint operator; because of library implementation <=operator drools will emit superfluous events

Mathematical expressions of the event emitters include the following operations:
Arithmetical operations (*, /, +, −)
Aggregating functions
   Has a mathematical expression as a first parameter. The result of the calculation of this expression will be used as a data source for an aggregating operation
   “sd”—standard deviation function
   “avg”—average function
   “mean”—average function of several data expressions
Operands for these operations can be
   Numbers
   Identifiers of the data source
   Results of the inner operations
Mathematical expressions can be prioritized using parenthesizes
Some of the operands, such as a data source identifier, a sub expression and aggregating functions, can be specified with filters

Filters define the behavior of data expression values emitting in the case that new input values cannot be calculated or there are no available values in the data source.
“ignorable”—means that the result of the data expression specified with this filter can be ignored during other calculations, if its new value is undefined (cannot be calculated)
“repeat”—means that the last calculated value of the data expression will be repeated, if its new value is undefined (cannot be calculated)
   Time—frequency of repeating values
“expires”—means that the result value of the data expression will always be undefined, if the last value was calculated earlier than the specified timeout
   Timeout of expiration

The standard deviation function has two overloading
By time—calculates a standard deviation value within the time interval
By data values count—calculates a standard deviation value for the last data values from the series
Emits an event with a calculated standard deviation value

The average function has two overloading
By time—calculates an average value within the time interval
By data values count—calculates an average value for the last data values from the series
Emits events with a calculated average value

The mean function calculates the average value of several data expressions.

The abs function calculates the absolute value of the data expression.

The max function calculates the maximal value of several data expressions.

The min function calculates the minimal value of several data expressions.

The pow function calculates the power of data expressions. It includes two parameters:
First parameter—base of power.
Second—exponent

It should be noted that this grammar is only an example and can be reformulated as well as extended.

FIG. 3 shows an embodiment of a sequence of method steps for detecting correlations within data received from a technical system 100.

In a first step 301, numerical data 11 are received from the technical system 100. The numerical data 11 are processed in a second step 302 by converting the numerical data 11 into text-based data and by detecting predefined events in the text-based data. This can be done using the above grammar.

In a third step 303, the detected events are compared with predefined queries to provide a comparison result, wherein the predefined queries describe correlations between detected events. The queries can also be formulated using the above described grammar.

In a fourth step 304, a signal 12 is outputted based on the provided comparison result.

Although the present invention has been disclosed in the form of preferred embodiments and variations thereon, it will be understood that numerous additional modifications and variations could be made thereto without departing from the scope of the invention.

For the sake of clarity, it is to be understood that the use of ‘a’ or ‘an’ throughout this application does not exclude a plurality, and ‘comprising’ does not exclude other steps or elements.

### REFERENCE NUMERALS

1 receiving unit
2 processing unit
3 comparison unit
4 signaling unit
5 input unit
6 data base
7 mathematical processing unit
8 process recognition unit
9 event processing unit
10 computer device
11 numerical data
12 signal
13 input information
14 processor
15 event emitter
16 processor
17 logic rules converter
18 data base
19 display unit
20 sensors
100 technical system
301-304 method steps

1. A computer device for detecting correlations within data received from a technical system, the computer device comprising:
a receiving unit for receiving numerical data from the technical system,
a processing unit for processing the numerical data by converting the numerical data into text-based data and by detecting predefined events in the text-based data,
a comparison unit for comparing the detected events with predefined queries to provide a comparison result, wherein the predefined queries describe correlations between detected events, and
a signaling unit for outputting a signal based on the provided comparison result.

2. The computer device according to claim 1, wherein the signaling unit is adapted to output a signal when the comparison result is positive.

3. The computer device according to claim 1, wherein the receiving unit is adapted to receive numerical sensor data from at least one sensor of the technical system and/or numerical measurement data from at least one measurement unit of the technical system.

4. The computer device according to claim 1,
wherein the receiving unit is adapted to receive operation commands from at least one control unit of the technical system, and
wherein the comparison unit is adapted to compare the detected events and the operation commands with predefined queries.

5. The computer device according to claim 1, wherein a predefined query describes a correlation between a plurality of detected events.

6. The computer device according to claim 5, wherein the predefined query describes a temporal correlation between the plurality of detected events.

7. The computer device according to claim 5, wherein the predefined query describes a logical correlation between the plurality of detected events.

8. The computer device according to claim 1, wherein the processing unit includes a filter for filtering specific detected events.

9. The computer device according to claim 1, wherein the detected events include at least one of a trend of the detected event, a gap within the detected event, a minimum value of the detected event, a maximum value of the detected event, and an average value of the detected event.

10. The computer device according to claim 1, further comprising
an input unit for receiving input information from a user, the input information including predefined queries.

11. The computer device according to claim 10, wherein the input information is in text-based form.

12. A technical system comprising
a plurality of sensors for providing numerical data from the technical system, and
a computer device according to claim 1.

13. The technical system according to claim 12, wherein the technical system is one of a wind turbine, a gas turbine, a steam turbine, a compressor, and a generator.

14. A method for detecting correlations within data received from a technical system, the method comprising:
receiving numerical data from the technical system,
processing the numerical data by converting the numerical data into text-based data and by detecting predefined events in the text-based data,
comparing the detected events with predefined queries to provide a comparison result, wherein the predefined queries describe correlations between detected events, and
outputting a signal based on the provided comparison result.

15. A computer program product comprising a program code for executing the method for detecting correlations within data received from a technical system according to claim 14.
